(19) United States
(12) Patent Application Publication
(10) Pub. No.: US 2026/0022310 A1
(43) Pub. Date: Jan. 22, 2026

(54) Carpet Cleaning Compound

(71) Applicant: Reginald Wyatt, Riverside, CA (US)

(72) Inventor: Reginald Wyatt, Riverside, CA (US)

(21) Appl. No.: 19/264,304

(22) Filed: Jul. 9, 2025

Related U.S. Application Data
(60) Provisional application No. 63/673,005, filed on Jul. 18, 2024.

(51) Int. Cl. C11D 3/14; C11D 17/00

(52) U.S. Cl. CPC C11D 3/14; C11D 17/0013

(57) ABSTRACT

A method of manufacturing and using a cleaning solution for use with multiple surfaces. An objective of the present invention is to provide the user with a superior cleaning solution that cleans, deodorizes, and brightens any target surface. The quantities of each ingredient in the cleaning solution can be adjusted to meet the needs of the end-user (i.e., multi-purpose cleaner, carpet cleaner). In addition, the cleaning solution uses significantly less water compared to other name brand products. When using the present invention to clean large surface areas such as a carpeted office floor, using less water saves both time and money for the end-user. Further, a method of using the present invention may include applying sawdust over the target surface and then pouring the cleaning solution over the sawdust. Once dispersed, the sawdust helps absorb and lift the contaminates off the carpet floor.

### FIELD OF THE INVENTION

The present invention relates generally to a cleaning solution. More specifically, the present invention is a proprietary cleaning agent comprised of various ingredients and compounds, and the method to create the cleaning solution.

### BACKGROUND OF THE INVENTION

Cleaning solutions/agents are substances, typically taking form in liquids, powder or sprays, used to remove dirt, grime, dust, stains, and clutter on various surfaces. The purpose of using cleaning solutions include health, beauty, removing offensive odor, and avoiding the spread of dirt and contaminants to oneself and others. There are many types of cleaning solutions on the market today, many of which claim to be more effective than others. However, not all cleaning solutions perform as expected. In addition, different types of cleaning solutions are needed for different types of surfaces.

An objective of the present invention is to provide the user with a superior cleaning solution that cleans, deodorizes, and brightens any surface. The quantities of each ingredient in the cleaning solution can be adjusted to meet the needs of the end-user (i.e., multi-purpose cleaner, carpet cleaner). In addition, the present invention uses significantly less water compared to other name brand products. For large projects such as carpeted office floor, using less water to clean the carpet saves both time and money for the end-user.

### BRIEF DESCRIPTION OF THE DRAWINGS

FIG. 1 is a schematic view of preparing a cleaning solution, according to a first embodiment of the present invention.

FIG. 2 is a schematic view of preparing a cleaning solution, according to a second embodiment of the present invention.

FIG. 3 is an illustration view showing a method of using the cleaning solution, according to the first embodiment.

FIG. 4 is an illustration view showing a method of using the cleaning solution, according to the second embodiment.

FIG. 5 is a flowchart illustrating an overall process and a method of the present invention, according to the first embodiment.

FIG. 6 is a flowchart illustrating an overall process and a method of the present invention, according to the second embodiment.

### DETAIL DESCRIPTIONS OF THE INVENTION

All illustrations of the drawings are for the purpose of describing selected versions of the present invention and are not intended to limit the scope of the present invention.

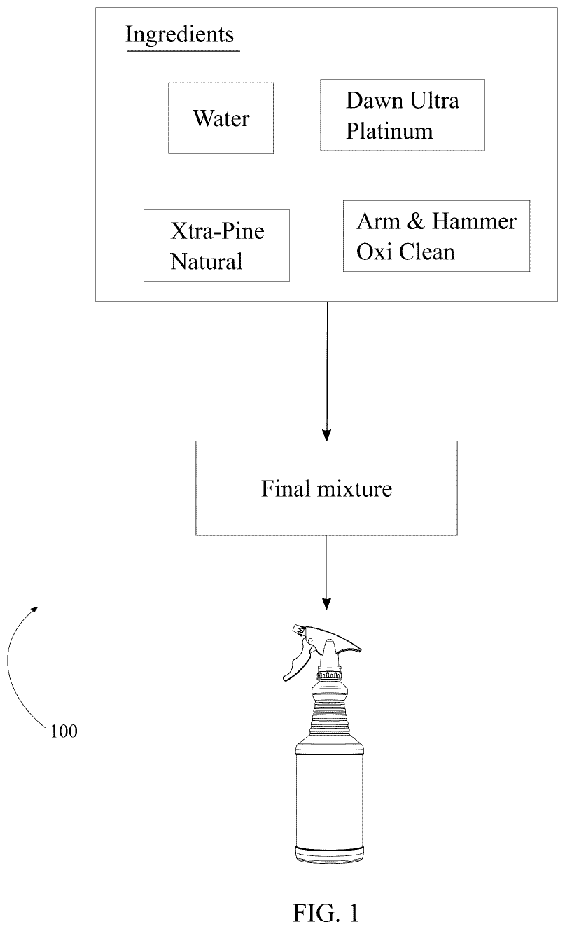

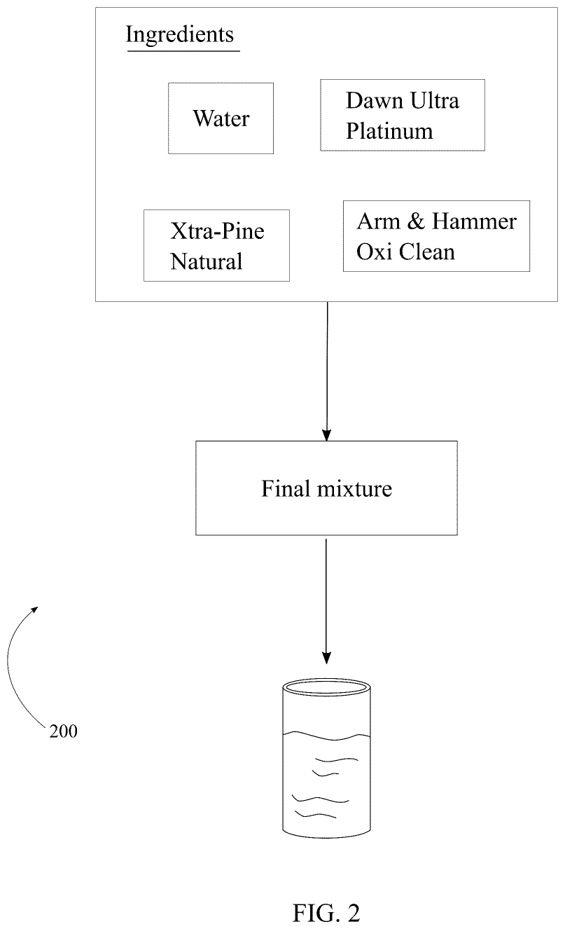

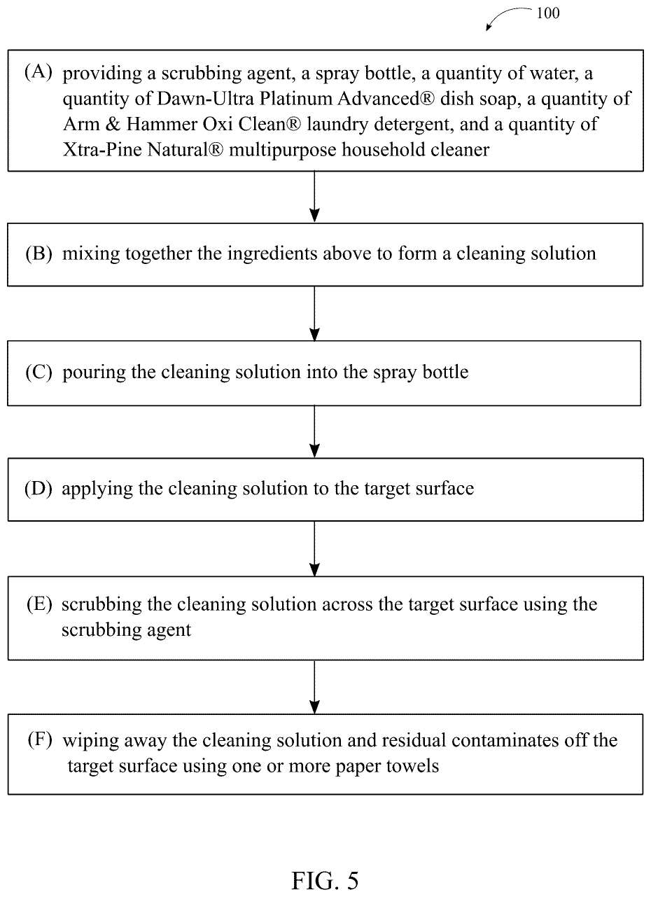

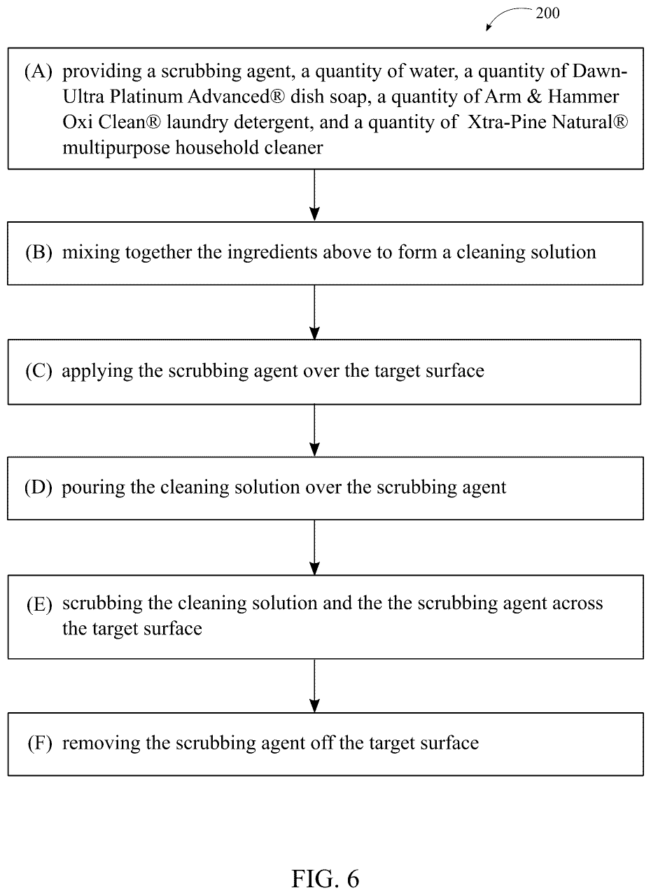

In reference to FIGS. 1-6, the present invention is a cleaning solution that can be adapted to meet the needs of the user. An objective of the present invention is to provide users with a cleaning solution that can be used to remove grime, grease, oil, and other contaminates from any target surface. Hereinafter, the term “target surface” refers to any surface the user intends to clean, including but not limited to countertops, work surfaces, laminated floors, and carpeted floors.

First, at Step A, an overall process or a method of manufacturing the cleaning solution comprises: providing a quantity of water, a quantity of Dawn-Ultra Platinum Advanced® detergent, a quantity of Arm & Hammer Oxi Clean® detergent, and a quantity of Xtra-Pine Natural® cleaner. Thus, the above ingredients constitute the system of the present invention. It is understood that additional embodiments of the present invention may invoke various proportions and/or variations of ingredients.

Next, at step B, the overall process or method may include mixing together the above ingredients in a suitable-sized container to form the cleaning solution. When mixed together, the combination of ingredients and their corresponding quantities provide superior benefits over the leading brands of cleaning solutions. For carpet cleaning in particular, the Dawn-Ultra Platinum Advanced® detergent is designed to remove grease, oil, and dirt from the carpet. Further, the Arm & Hammer Oxi Clean® detergent is designed to brighten and whiten the carpet. Lastly, the Xtra-Pine Natural® cleaner is designed to disinfect and deodorize the carpet.

As an unexpected result, the present invention uses 95% less water compared to other leading brands of cleaning solutions. Using less water has a number of advantages for both the manufacturer and the consumer of the cleaning solution. For the manufacturer, using less water reduces both production costs and shipping costs associated with producing and shipping the cleaning solution to wholesale distributors. For the consumer, using less water saves both time and money to complete the task at hand. For instance, when tasked with cleaning an entire carpeted floor of a large office building, using less water saves on operating costs by purchasing fewer quantities of cleaning solution. In addition, using less water also reduces the amount of downtime associated with stopping and refilling the cleaning machine. By refilling less often, the user can complete the cleaning task much quicker as compared to using other cleaning solutions.

Depending on the target surface being cleaned, the quantities of each ingredient can vary. In a first embodiment for a multi-purpose cleaner 100, the quantity of water is approximately 5 gallons, the quantity of Dawn-Ultra Platinum Advanced® detergent is approximately 12 oz., the quantity of Arm & Hammer Oxi Clean® detergent is approximately 30 oz., and the quantity of Xtra-Pine Natural® cleaner is approximately 30 oz.

In an alternative embodiment for a multi-purpose cleaner 100, the quantity of water is approximately 5 gallons, the quantity of Dawn-Ultra Platinum Advanced® detergent is approximately 14 oz., the quantity of Arm & Hammer Oxi Clean® detergent is approximately 28 oz., and the quantity of Xtra-Pine Natural® cleaner is approximately 32 oz.

In a second embodiment for a carpet cleaner 200, the quantity of water is approximately 5 gallons, the quantity of Dawn-Ultra Platinum Advanced® detergent is approximately 14 oz., the quantity of Arm & Hammer Oxi Clean® detergent is approximately 20 oz., and the quantity of Xtra-Pine Natural® cleaner is approximately 32 oz.

After selecting one of the embodiments above and mixing the ingredients together to form the desired cleaning solution (Steps A and B), the user can then begin the next set of steps to clean the target surface. Similar to the variations in ingredients outlined above, the following steps for cleaning the target surface can also be performed in multiple variations to accommodate user-specific requirements.

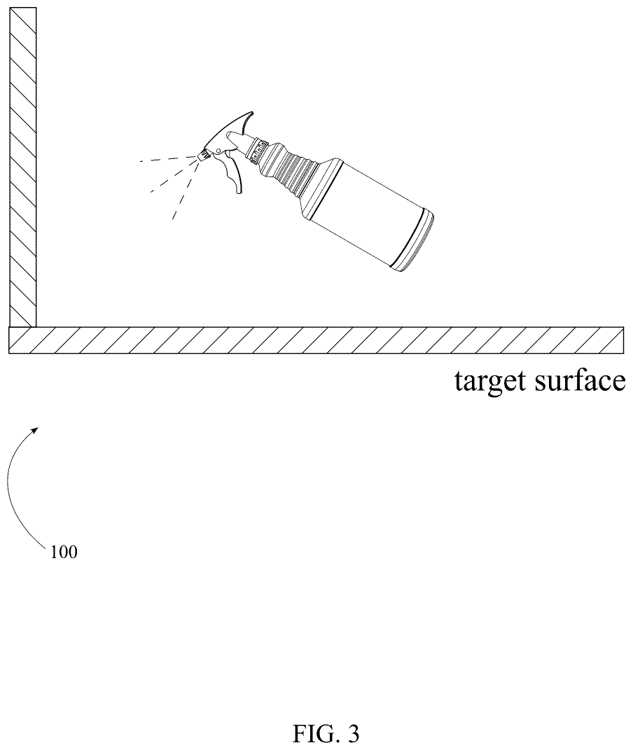

For use as a multi-purpose cleaner 100, Step A may further include providing a portable container and a scrubbing agent. As seen in FIG. 1, the portable container can be in the form of a spray bottle and the scrubbing agent can be any abrasive material such as a scouring pad and/or sponge. Continuing at Step C, the method may further include pouring the cleaning solution into the portable container. Then, at Step D, the method may include applying the cleaning solution to the target surface, as seen in FIG. 3. By using the spray bottle, the user can spot clean hard to reach areas such as toe kicks and table top corners. Next, at Step E, the method may include scrubbing the cleaning solution across the target surface using the scrubbing agent. Here, the scrubbing agent helps lift the contaminates off the target surface, thereby making it easier to clean. Finally, in Step F, the method may include wiping away the cleaning solution and residual contaminates off the target surface using one or more paper towels or a wash cloth.

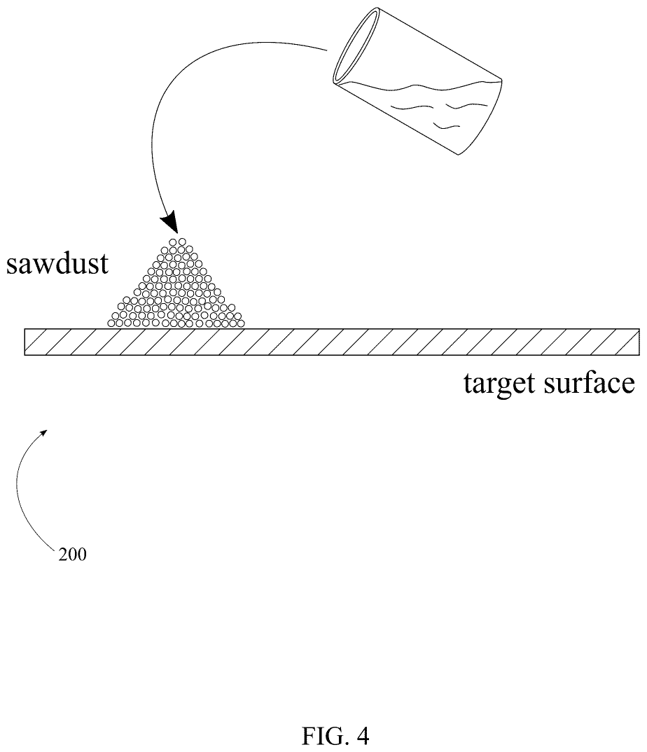

For use as a carpet cleaner 200, Step A may further include providing a scrubbing agent. As seen in FIG. 4, the scrubbing agent can be in the form of sawdust, preferably white pine sawdust. Unlike other common scrubbing materials on the market today, white pine sawdust is all natural and highly absorbent, making it an excellent substitute for man-made scrubbing materials. However, it is understood the scrubbing agent for this embodiment is not limited to sawdust and may include any other suitable element for general cleaning use. Continuing at Step C, the method may include applying the sawdust over the target surface. Next, at Step D, the method may include pouring the cleaning solution over the sawdust. Next, at Step E, the method may include scrubbing the cleaning solution and the sawdust across the target surface. This step can be performed either by hand or by a carpet cleaning machine, wherein the sawdust is dispersed across the target surface in order to absorb the contaminates. Finally, in Step F, the method may include removing the sawdust off the carpet floor using a vacuum cleaner or a carpet cleaning machine.

Although the invention has been explained in relation to its preferred embodiment, it is to be understood that many other possible modifications and variations can be made without departing from the spirit and scope of the invention as hereinafter claimed.

1. (canceled)

2. (canceled)

3. (canceled)

4. (canceled)

5. (canceled)

6. (canceled)

7. A method for cleaning a carpeted floor, the method comprising the steps:
(A) providing a scrubbing agent and a cleaning solution;
(B) applying the scrubbing agent over a target surface, wherein the scrubbing agent is white pine sawdust;
(C) pouring the cleaning solution over the scrubbing agent; and
(D) scrubbing the cleaning solution and the scrubbing agent across the target surface.

8. (canceled)

9. (canceled)

10. (canceled)

11. (canceled)

12. (canceled)

13. (canceled)

14. (canceled)

15. (canceled)

16. (canceled)

17. (canceled)
